(19) United States
(12) Patent Application Publication
(10) Pub. No.: US 2007/0057055 A1
(43) Pub. Date: Mar. 15, 2007

(54) CARD READER

(76) Inventor: Dar-Shan Horng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,599

(22) Filed: Oct. 25, 2005

(30) Foreign Application Priority Data
Sep. 12, 2005 (TW) 94131267

(51) Int. Cl. G06K 7/06

(52) U.S. Cl. 235/441

(57) ABSTRACT

A card reader including a housing, a reading module, a sliding element having a first hook, an elastic element, a second hook, and a switch element is provided. The housing has an inserting hole, and the reading module is disposed in the housing. The sliding element is disposed at one side within the housing. The elastic element connects the sliding element and the housing. The second hook is disposed in the housing. When the smart card is inserted into the card reader, the sliding element is driven by the smart card to move along the inserting direction, and the first hook locks with the second hook. The second hook is driven by the switch element to unhook the second and the first hook. A force is provided to the sliding element by the elastic element such that the sliding element can return to the initial position.

### CROSS-REFERENCE TO RELATED APPLICATION

This application claims the priority benefit of Taiwan application serial no. 94131267, filed on Sep. 12, 2005. All disclosure of the Taiwan application is incorporated herein by reference.

### BACKGROUND OF THE INVENTION

1. Field of Invention

The present invention relates to a card reader and more particularly, to a card reader that is easy to be assembled and requires fewer components.

2. Description of Related Art

As the technology continues to advance, various types of chip cards for storing different kinds of data are becoming popular. For example, the types of chip cards at the present stage can work as health care card for saving case history data, ATM card for accessing deposit, withdraw and account balance or power-starting chip card providing anti-theft and recording functions, etc. These chip cards are all used in our daily lives. Therefore, as the using rate of the chip card rises, the card readers are also getting popular.

Please refer to the card reader disclosed in U.S. Pat. No. 6,736,318. This card reader holds the smart card in the card reader or ejects the card from the card reader through a linking-up mechanism. While the card reader holds the smart card in the card reader or ejects the card from the card reader through this linking-up mechanism, the conventional card readers have a lot of components, and the linking-up relationships among the components are quite complicated. Therefore, the yield of the card reader assembly is low, and the production cost cannot be reduced effectively. In addition, if the card reader is installed in a shaky state, such as in a running car, when there is a foreign object falling into the card reader, due to the number of components in the card reader and the operation range of the components, the foreign object can easily get stuck in the components, bringing down the operation and accuracy of the card reader.

### SUMMARY OF THE INVENTION

Accordingly, the present invention is directed to provide a card reader that is easy to be assembled and requires fewer components.

To achieve the aforementioned or other purposes, the present invention is to offer a card reader suitable for reading the data stored in a smart card. The card reader includes a housing, a reading module, a sliding element having a first hook, an elastic element, a second hook, and a switch element. The housing has an inserting hole, and the reading module is disposed in the housing. The sliding element is disposed at one side within the housing. In addition, the elastic element connects the sliding element and the housing. The second hook is disposed in the housing, wherein the sliding element is suitable to be driven by the smart card to move along the inserting direction, and the first hook locks with the second hook. The switch element is suitable for driving the second hook to be unhooked with the first hook. The sliding element resumes to its initial position by a force provided by the elastic element.

In an embodiment of the present invention, the housing includes a bottom shell and a top cover assembled on the bottom shell. The housing has a first sliding element guiding slot and a second sliding element guiding slot. The first sliding element is disposed at one side of the bottom shell, and the first sliding element guiding slot corresponds to the moving path of the sliding element. In addition, the first sliding element guiding slot has a hook portion. The second sliding element guiding slot is disposed at the bottom shell, and the second sliding element guiding slot corresponds to the moving path of the sliding element.

In an embodiment of the present invention, the reading module includes one connector and a flexible printed circuit board electrically connecting with the connector. The connector includes a base and a plurality of data transmission pins disposed on the base.

In an embodiment of the present invention, the card reader further comprises a connecting rod connecting to the sliding element. When the smart card is inserted into the card reader, the sliding element is driven by the smart card to move along the inserting direction, the connecting rod is then driven by the sliding element. When the first hook locks with the second hook, the connecting rod locks the smart card to prevent the smart card from ejecting.

In an embodiment of the present invention, the housing has a first protruding structure disposed below the connecting rod. The first protruding structure has a first horizontal guiding surface and a first sloping guiding surface, and the connecting rod has a first horizontal supporting surface and a first sloping supporting surface connecting with the first horizontal supporting surface. The first horizontal supporting surface and the first sloping supporting surface are supported by the first horizontal guiding surface and the first sloping guiding surface respectively. When the sliding element is driven by the smart card to move along the inserting direction, the connecting rod lifts up and locks the smart card. In addition, the connecting rod has a blocking portion that is driven by the sliding element to lift up and lock the smart card.

In an embodiment of the present invention, the housing has a second protruding structure disposed above the connecting rod. The second protruding structure has a second horizontal guiding surface and a second sloping guiding surface, while the connecting rod has a second horizontal supporting surface and a second sloping supporting surface connected with the second horizontal supporting surface, and the second horizontal supporting surface and the second sloping supporting surface are supported by the second horizontal guiding surface and the second sloping guiding surface respectively. When the smart card ejects, the connecting rod is pressed down by the housing.

In an embodiment of the present invention, the elastic element includes an extension spring and/or a compression spring.

In an embodiment of the present invention, the switch element is suitable for driving the second hook to move to the unhooking direction, and the unhooking direction is vertical to the inserting direction of the smart card. The switch element includes an electromagnetic driver and a spring. The electromagnetic driver is connecting with the second hook, and the electromagnetic driver is suitable for driving the second hook to move to the unhooking direction, so as to unhook the first hook and the second hook. The spring is disposed between the electromagnetic driver and the second hook.

According to above description, the card reader of the present invention has simple structure, less components and high assembly yield.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded diagram of a card reader according to an embodiment of the present invention.

FIG. 2 is a schematic block diagram of internal components within a card reader according to an embodiment of the present invention.

FIG. 3 is a three-dimensional diagram of a card reader according to an embodiment of the present invention.

FIG. 4 is a schematic block diagram in which a smart card is inserted into a card reader according to an embodiment of the present invention.

FIGS. 5A-5C are flow charts showing the movements of connecting rod when a smart card is inserted into a card reader.

FIGS. 6A-6C are flow charts showing the second protruding structure guiding the sliding rod to its initial position.

### DESCRIPTION OF EMBODIMENTS

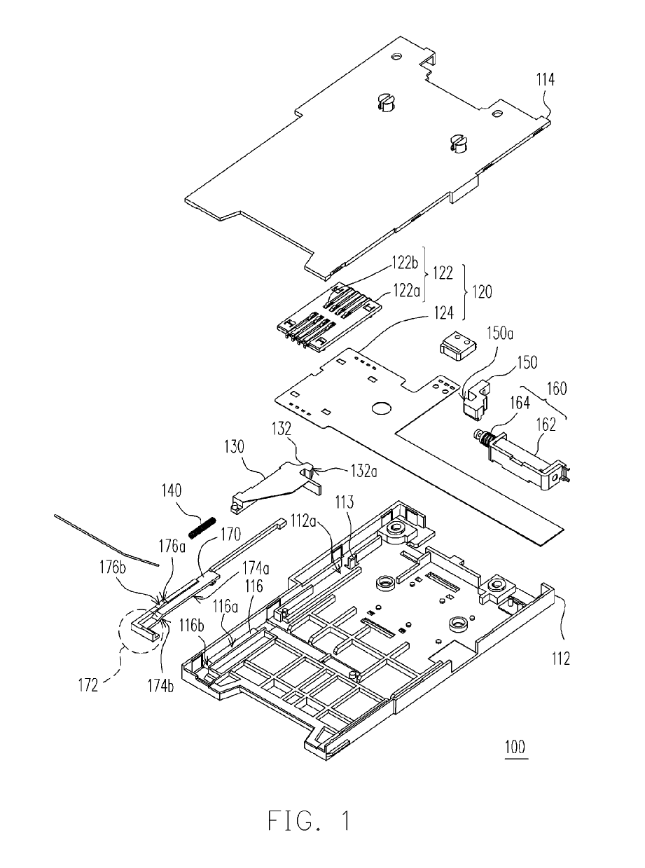

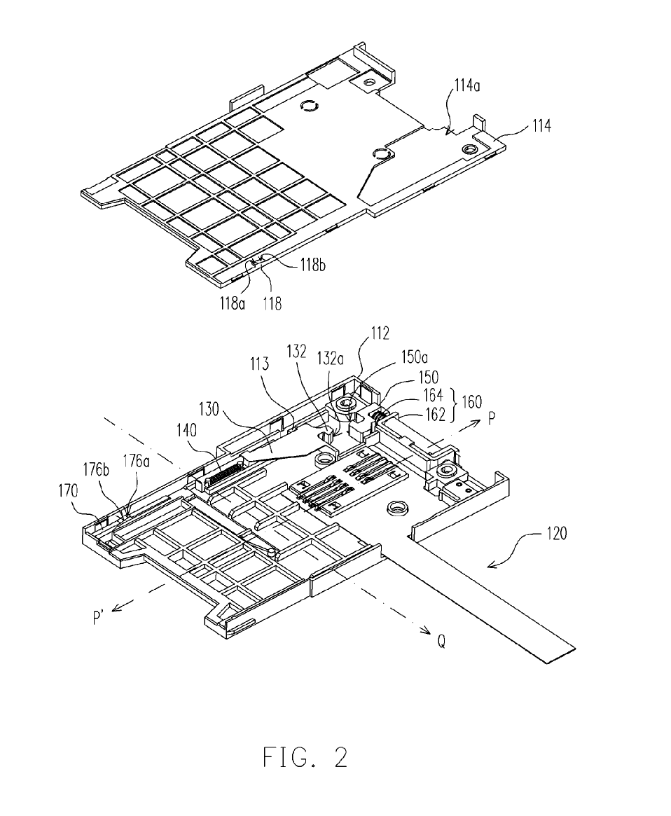

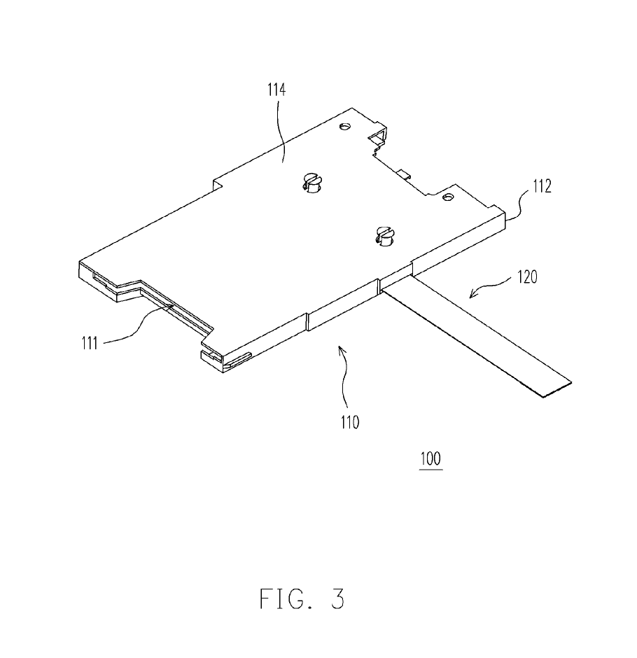

FIG. 1 is an exploded diagram of a card reader according to an embodiment of the present invention, FIG. 2 is a schematic block diagram of internal components within a card reader according to an embodiment of the present invention, and FIG. 3 is a three-dimensional diagram of a card reader according to an embodiment of the present invention. Referring to FIG. 1, FIG. 2 and FIG. 3, the card reader 100 reads the data stored in the smart card 200. The card reader comprises a housing 110 (shown as FIG. 3), a reading module 120, a sliding element 130 having a first hook 132, an elastic element 140, a second hook 150, and a switch element 160. The housing 110 has an inserting hole 111 (shown as FIG. 3), and the reading module 120 is disposed in the housing 110. The sliding element 130 is disposed at one side within the housing 110. In addition, the elastic element 140 connects the sliding element 130 and the housing 110. The second hook 150 is disposed in the housing 110. The sliding element 130 is driven by the smart card 200 to move along the inserting direction P, and the first hook 132 locks with the second hook 150. The second hook 150 is driven by the switch element 160 to be unhooked with the first hook 132. A force is provided to the sliding element 130 by the elastic element 140 such that the sliding element 130 can return to the initial position along direction P′.

More particularly, the housing 110 of the embodiment includes a bottom shell 112 and a top cover 114 assembled on the bottom shell 112. Certainly, the housing 110 of the present invention can be made of components in other types or quantity. In order for the card reader 100 to read the data stored in the smart card 200 smoothly, the present invention can use a point-contact reading module, friction type reading module or other types. The following is a detailed configuration of reading module 120. In the embodiment of the present invention, the reading module 120 disposed in the housing 110 comprises a connector 122 and a flexible printed circuit board 124. The connector 122 includes a base 122a and a plurality of data transmission pins 122b disposed on the base 122a. The data transmission pins 122b contact with the smart card 200 in order to read data stored in the smart card 200 or store the data in the smart card 200. The flexible printed circuit board 124 is electrically connecting with the data transmission pins 122b of the connector 122. By means of the connector 122 and the flexible printed circuit board 124, the card reader 100 can read the data stored in a smart card 200 or store the data in the smart card 200.

The sliding element 130 shown in FIG. 1 is disposed on the bottom shell 112, for example. In order to avoid the sliding element 130 from tilting when moving or disengaging from the bottom shell 112, a first sliding element guiding slot 112a is installed on the bottom shell 112, and a hook portion 113 is set beside the first sliding element guiding slot 112a. Particularly, the sliding element 130 moves along the first sliding element guiding slot 112a, and the hook portion 113 is used to limit the sliding element 130 to avoid sliding element 130 from tilting or disengaging from the bottom shell 112 due to the collision as the first hook 132 locks to the second hook 150.

In addition, in order to avoid the sliding element 130 from aberration when moving, a second sliding element guiding slot 114a (shown as FIG. 2) is installed on the top cover 114. In general, the distribution range of the second sliding element guiding slot 114a is corresponding to the moving path of the sliding element 130, which is used for guiding the sliding element 130 to move along the right path. In addition, the elastic element 140 connects between the sliding element 130 and the bottom shell 112. In the embodiment, the elastic element 140 is an extension spring disposed between the sliding element 130 and inserting hole 111. However, in other embodiments, the elastic element 140 may be a compression spring disposed at one side of the second hook 150 and located on the moving path of the sliding element 130.

Referring to FIG. 1 and FIG. 2, the switch element 160 is assembled on the bottom shell 112, and the second hook 150 driven by the switch element 160 is disposed on the moving path of the sliding element 130. In an embodiment, the switch element 160 includes an electromagnetic driver 162 and a spring 164, wherein the electromagnetic driver 162 is connecting to the second hook 150, and the spring 164 is disposed between the electromagnetic driver 162 and the second hook 150. It is noted that, the switch element 160 of the embodiment is suitable for driving the second hook 150 to move to the unhooking direction Q that is vertical to the inserting direction P of the smart card 200.

According to above description, in order to prevent the smart card 200 from dropping out from the card reader 100 after the smart card 200 is inserted into the card reader 100, the card reader 100 in the present invention can further comprises a connecting rod 170 and a first protruding structure 116. The connecting rod 170 is connecting to the sliding element 130 and has a blocking portion 172. In addition, the first protruding structure 116 is disposed above the bottom shell 112 of the housing 110, and the first protruding structure 116 has a first horizontal guiding surface 116a (shown as FIG. 2) and a first sloping guiding surface 116b (shown as FIG. 2). Referring to FIG. 1, the connecting rod 170 has a first horizontal supporting surface 174a and a first sloping supporting surface 174b corresponding with the first protruding structure 116, and the first sloping supporting surface 174b is connecting with the first horizontal supporting surface 174a. In other words, the first horizontal supporting surface 174a and the first sloping supporting surface 174b are supported by the first horizontal guiding surface 116a and the first sloping guiding surface 116b of the first protruding structure 116 respectively. The blocking portion 172 locks the smart card 200 to avoid the smart card 200 dropping out from the card reader 100 after the smart card 200 is inserted into the card reader 200.

To provide better explanation of the card reader 100 mechanism for holding and ejecting the smart card 200, detailed description about the movements among the components is given below.

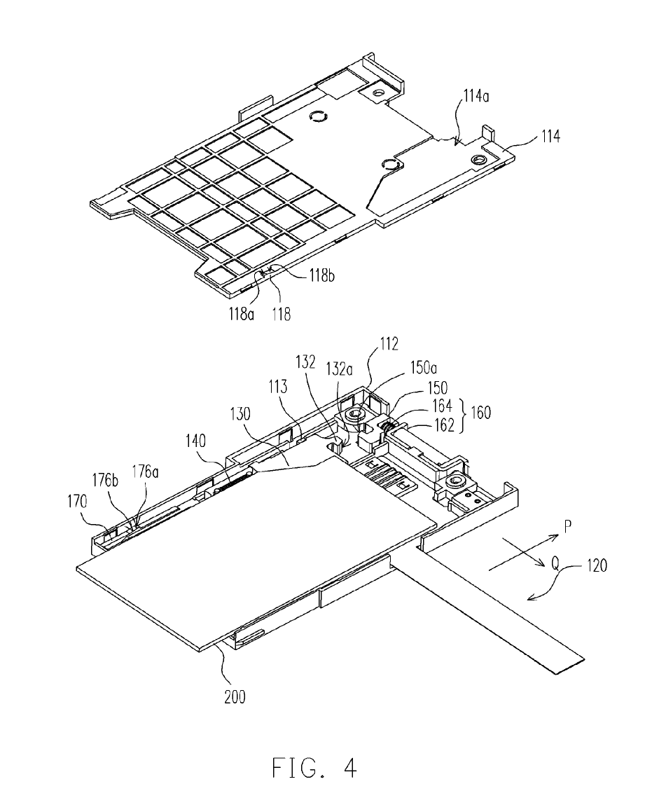

FIG. 4 is a schematic diagram in which a smart card is inserted into a card reader according to an embodiment of the present invention. Referring to FIG. 3 and FIG. 4, when the smart card 200 is inserted into the inserting hole 111 of the card reader 100, the smart card 200 drives the sliding element 130 to move. At this moment, the sliding element 130 moves along the first sliding element guiding slot 112a of the bottom shell 112, and the outline of the second sliding element guiding slot 114a of the top cover 114 will limit the moving path of the sliding element 130, and the sliding element 130 extends the elastic element 140. At the meantime, the sliding element 130 drives the connecting rod 170 to move to the inserting direction P of the smart card 200.

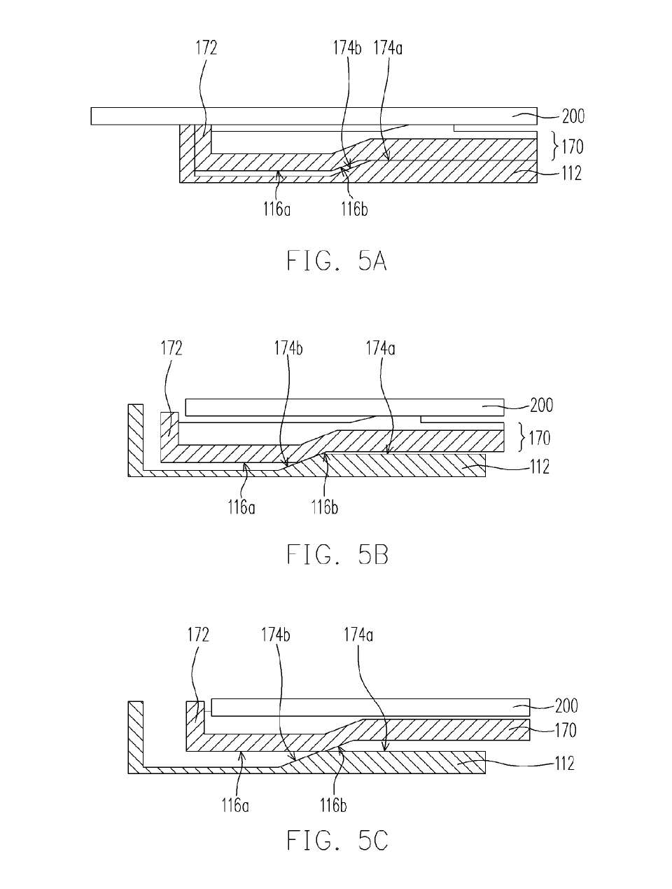

FIGS. 5A-5C are flow charts showing the movements of a connecting rod when a smart card is inserted into a card reader. Referring to FIG. 4, FIG. 5A and FIG. 5B, when the connecting rod 170 moves to the inserting direction P of the smart card 200, the first protruding structure 116 on the bottom shell 112 guides the connecting rod 170 to lift up. More particularly, as the sliding element 130 drives the connecting rod 170 to move, the first horizontal supporting surface 174a and the first sloping supporting surface 174b of the connecting rod 170 perform relative movements on the first horizontal guiding surface 116a and the first sloping guiding surface 116b of the housing 100 respectively. Therefore, the connecting rod 170 is lifted up, as shown in FIG. 5B.

Referring to FIG. 4 and FIG. 5C, as the smart card 200 drives the sliding element 130 to move, the first hook 132 contacts the second hook 150, and the first supporting surface 132a of the first hook 132 performs relative movements on the second supporting surface 150a of the second hook 150 so that the first hook 132 presses the second hook 150, and the spring 164 of the switch element 160 connecting to the second hook 150 gains restoring force by the compression. When the first supporting surface 132a stops the relative movements on the second supporting surface 150a, the spring 164 provides the restoring force of the second hook 150 to lock the first hook 132 with the second hook 150.

According to above description, when the first hook 132 locks with the second hook 150, the smart card 200 is unable to drive the sliding element 130 to move. At this moment, the blocking portion 172 of the connecting rod 170 locks the smart card 200 to prevent the smart card 200 from ejecting from the card reader 100, as shown in FIG. 5C.

Referring to FIG. 2, when the smart card 200 ejects from the card reader 100, the electromagnetic driver 162 of the switch element 160 drives the second hook 150 to move to the unhooking direction Q that is vertical to the inserting direction P of the smart card 200. At this moment, the second hook 150 leaves the first hook 132.

When the second hook 150 leaves the first hook 132, the extended elastic element 140 provides a restoring force to the sliding element 130, driving the sliding element 130 to move to the direction P′ opposite to the inserting direction P of the smart card 200.

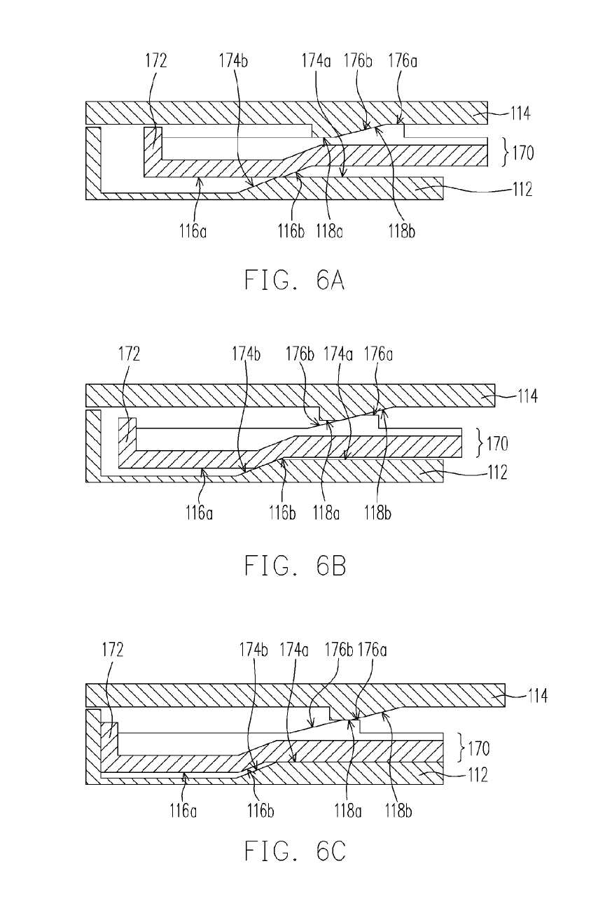

FIGS. 6A-6C are flow charts showing the second protruding structure guiding the connecting rod to its initial position. Referring to FIG. 4 and FIGS. 6A-6C, the sliding element 130 drives the connecting rod 170 to move to the direction that is opposite to the inserting direction of the smart card 200. In order to avoid the connecting rod 170 from being unable to return to the initial position, the top cover 114 of the housing 110 has a second protruding structure 118 to drive the connecting rod 170 to return to the initial position. More particularly, the second protruding structure 118 has a second horizontal guiding surface 118a and a second sloping guiding surface 118b connecting with the second horizontal guiding surface 118a. The connecting rod 170 has a second horizontal supporting surface 176a and a second sloping supporting surface 176b corresponding to the second horizontal guiding surface 118a and the second sloping guiding surface 118b respectively. Thus, when the sliding element 130 drives the connecting rod 170 to move to the direction that is opposite to the inserting direction of smart card 200, by means of the relative movements between the second sloping guiding surface 118b and the second sloping supporting surface 176b and between the second horizontal guiding surface 118a and the second horizontal supporting surface 176a, the connecting rod 170 is driven by the second protruding structure 118 and moves down, so that both the connecting rod 170 and the sliding element 130 return to their initial positions respectively.

In conclusion, the read carder of present invention has at least the following advantages.

1. There are fewer components than the conventional card readers, so that it's possible to improve the yield of products and reduce the production cost.

2. The linking-up relationship among the components are simple, and the operation range of the components are small, which can reduce the possibilities of the card reader being unable to operate due to stuck foreign objects.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A card reader, suitable for reading the data stored in a smart card; the card reader comprising:
a housing with a inserting hole;
a reading module disposed in said housing;
a sliding element having a first hook, disposed at one side within said housing;
an elastic element connecting between said sliding element and said housing;
a second hook disposed in said housing, wherein said smart card drives said sliding element to move along the inserting direction of said smart card, and said first hook locks with said second hook; and
a switch element, suitable for driving said second hook, wherein when said switch element drives said second hook, the first hook and the second hook are unhooked, and a force is provided to said sliding element by said elastic element such that said sliding element return to the initial position.

2. The card reader as claimed in claim 1, wherein said housing comprises:
a bottom shell; and
a top cover assembled on said bottom shell.

3. The card reader as claimed in claim 2, wherein said housing has a first sliding element guiding slot disposed at one side of said bottom shell, and said first sliding element guiding slot corresponds to the moving path of said sliding element.

4. The card reader as claimed in claim 3, wherein said first sliding element guiding slot has a hook portion.

5. The card reader as claimed in claim 2, wherein said housing has a second sliding element guiding slot disposed at said top cover, and said second sliding element guiding slot corresponds to the moving path of said sliding element.

6. The card reader as claimed in claim 1, wherein said reading module comprises:
a connector; and
a flexible printed circuit board electrically connecting to said connector.

7. The card reader as claimed in claim 6, wherein said connector comprises:
a base; and
a plurality of data transmitting pins disposed on said base.

8. The card reader as claimed in claim 1, further comprising a connecting rod connecting to said sliding element, wherein when said smart card is inserted into said card reader, said sliding element is driven by said smart card to move along the inserting direction, said connecting rod is driven by said sliding element, and when said first hook locks with said second hook, said connecting rod locks said smart card to prevent said smart card from ejecting.

9. The card reader as claimed in claim 8, wherein said housing has a first protruding structure disposed below said connecting rod, said first protruding structure has a first horizontal guiding surface and a first sloping guiding surface, said connecting rod has a first horizontal supporting surface and a first sloping supporting surface connecting with said first horizontal supporting surface, and said first horizontal supporting surface and said first sloping supporting surface are supported by said first horizontal guiding surface and said first sloping guiding surface respectively; when said sliding element is driven by said smart card to move along the inserting direction, said connecting rod lifts up and locks said smart card.

10. The card reader as claimed in claim 9, wherein said connecting rod has a blocking portion suitable to be driven by said sliding element to lift up and lock said smart card.

11. The card reader as claimed in claim 9, wherein said housing has a second protruding structure disposed above the connecting rod, said second protruding structure has a second horizontal guiding surface and a second sloping guiding surface, and said connecting rod has a second horizontal supporting surface and a second sloping supporting surface connecting with said second horizontal supporting surface, and said second horizontal supporting surface and said second sloping supporting surface are supported by said second horizontal guiding surface and said second sloping guiding surface respectively; when said smart card ejects, said connecting rod is pressed down by said housing.

12. The card reader as claimed in claim 1, wherein said elastic element includes an extension spring and/or a compression spring.

13. The card reader as claimed in claim 1, wherein said switch element is suitable for driving said second hook to move to an unhooking direction, and said unhooking direction is vertical to the inserting direction of said smart card.

14. The card reader as claimed in claim 13, wherein said switch element comprises:
an electromagnetic driver connecting with said second hook, and said electromagnetic driver is suitable for driving said second hook to move to the unhooking direction, so as to unhook said first hook and said second hook; and
a spring disposed between said electromagnetic driver and said second hook.
